(19) United States
(12) Patent Application Publication
(10) Pub. No.: US 2016/0047780 A1
(43) Pub. Date: Feb. 18, 2016

(54) METHODS OF OPERATING ULTRASONIC TRANSDUCERS, AND ULTRASONIC DEVICES

(71) Applicant: Samsung Electronics Co., Ltd., Suwon-Si (KR)

(72) Inventors: Hyungjae SHIN, Seongnam-si (KR); Byunggil JEONG, Anyang-si (KR)

(21) Appl. No.: 14/573,710

(22) Filed: Dec. 17, 2014

(30) Foreign Application Priority Data
Aug. 18, 2014 (KR) 10-2014-0106965

(51) Int. Cl. G01N 29/24; G01S 15/89

(52) U.S. Cl. CPC G01N 29/2406; G01S 15/89; G01N 2291/101

(57) ABSTRACT

A method of operating a capacitive ultrasonic transducer may include: applying a first driving signal to a first electrode to generate a transmission pulse voltage during a transmission period; and/or applying a second driving signal to a second electrode to generate a transmission bias voltage during the transmission period and a receiving bias voltage, different from the transmission bias voltage, during a receiving period. A method of operating an ultrasonic transducer, including a pair of electrodes receiving pulse and DC bias voltages, may include: modulating the DC bias voltage into a transmission bias voltage and superposing the transmission bias and pulse voltages so as to apply the superposed voltage to the electrodes in a transmission mode; and/or modulating the DC bias voltage into a receiving bias voltage, different from the transmission bias voltage, and applying the receiving bias voltage to one of the electrodes in a receiving mode.

### CROSS-REFERENCE TO RELATED APPLICATION(S)

This application claims priority from Korean Patent Application No. 10-2014-0106965, filed on Aug. 18, 2014, in the Korean Intellectual Property Office (KIPO), the entire contents of which are incorporated herein by reference.

### BACKGROUND

1. Field

Some example embodiments may relate generally to ultrasonic devices including ultrasonic transducers. Some example embodiments may relate generally to methods of operating ultrasonic transducers.

2. Description of Related Art

Ultrasonic devices such as ultrasonic diagnosis devices may display tomograms of a target object, such as a person or an animal, on a monitor and may provide information necessary for diagnosis of the target object by radiating ultrasonic waves to the target object and/or detecting echo signals reflected from the target object.

Probes of ultrasonic diagnosis devices may be equipped with ultrasonic transducers capable of converting electric signals into ultrasonic signals and vice versa. Such an ultrasonic transducer may include a plurality of ultrasonic cells arranged in a one-dimensional (1D) or two-dimensional (2D) form. Micromachined ultrasonic transducers (MUTs) may be used as ultrasonic cells. According to a converting method, micromachined ultrasonic transducers may be classified as piezoelectric micromachined ultrasonic transducers (pMUTs), capacitive micromachined ultrasonic transducers (cMUTs), magnetic micromachined ultrasonic transducers (mMUTs), etc.

### SUMMARY

Some example embodiments may provide methods of operating ultrasonic transducers while improving transmission sensitivity of the ultrasonic transducer.

Some example embodiments may provide methods of operating ultrasonic transducers while improving receiving sensitivity of the ultrasonic transducer.

Some example embodiments may provide ultrasonic devices capable of improving transmission sensitivity.

Some example embodiments may provide ultrasonic devices capable of improving receiving sensitivity.

In some example embodiments, a method of operating a capacitive ultrasonic transducer, including a pair of electrodes, may comprise: applying a first driving signal to one of the pair of electrodes to generate a transmission pulse voltage during a transmission period; and/or applying a second driving signal to the other of the pair of electrodes to generate a transmission bias voltage during the transmission period and a receiving bias voltage that is different from the transmission bias voltage during a receiving period.

In some example embodiments, the method may satisfy the following conditions: Vd=Vpulse_Tx+Vbias_Tx; and/or Vbias_Tx:Vpulse_Tx=about 30:70 to about 40:60; where Vpulse_Tx refers to the transmission pulse voltage, Vbias_Tx refers to the transmission bias voltage, and Vd refers to a transmission driving voltage.

In some example embodiments, the method may satisfy the following conditions: Vbias_Rx:Vpulse_Rx=about 60:40 to about 70:30; where Vbias_Rx refers to the receiving bias voltage, Vpulse_Rx refers to a receiving pulse voltage defined as Vpulse_Rx=Vd−Vbias_Rx, and Vd refers to a transmission driving voltage.

In some example embodiments, a method of operating an ultrasonic transducer, including a pair of electrodes receiving a pulse voltage and a direct current (DC) bias voltage, may comprise: modulating the DC bias voltage into a transmission bias voltage and superposing the transmission bias voltage and the pulse voltage so as to apply the superposed voltage to the pair of electrodes in a transmission mode; and/or modulating the DC bias voltage into a receiving bias voltage that is different from the transmission bias voltage and applying the receiving bias voltage to one of the pair of electrodes in a receiving mode.

In some example embodiments, if a potential difference between the pair of electrodes in the transmission mode is defined as a driving voltage, a ratio of the transmission bias voltage to the driving voltage may be greater than or equal to about 30% and less than or equal to about 40%.

In some example embodiments, if a potential difference between the pair of electrodes in the transmission mode is defined as a driving voltage, a ratio of the receiving bias voltage to the driving voltage may be greater than or equal to about 60% and less than or equal to about 70%.

In some example embodiments, the ultrasonic transducer may be a capacitive micromachined ultrasonic transducer (cMUT).

In some example embodiments, an ultrasonic device may comprise: an ultrasonic probe, comprising a pair of electrodes and a capacitive ultrasonic transducer, configured to transmit and receive ultrasonic waves; a signal processing unit configured to generate information about an image of a target object from a received echo ultrasonic signal; and/or a driving signal generating unit configured to apply a direct current (DC) bias voltage and a pulse voltage to the pair of electrodes. The driving signal generating unit may be further configured to superpose a transmission bias voltage and a transmission pulse voltage and is configured to apply the superposed voltage to the pair of electrodes in a transmission mode. The driving signal generating unit may be further configured to apply a receiving bias voltage that is different from the transmission bias voltage to one of the pair of electrodes in a receiving mode.

In some example embodiments, the driving signal generating unit may comprise: a first driving signal generating unit configured to generate the transmission pulse voltage; and/or a second driving signal generating unit configured to generate the transmission bias voltage and the receiving bias voltage.

In some example embodiments, the capacitive ultrasonic transducer may satisfy the following conditions: Vd=Vpulse_Tx+Vbias_Tx; and/or Vbias_Tx:Vpulse_Tx=about 30:70 to about 40:60; where Vpulse_Tx refers to the transmission pulse voltage, Vbias_Tx refers to the transmission bias voltage, and Vd refers to a transmission driving voltage.

In some example embodiments, the capacitive ultrasonic transducer may satisfy the following conditions: Vbias_Rx:Vpulse_Rx=about 60:40 to about 70:30; where Vbias_Rx refers to the receiving bias voltage, Vpulse_Rx refers to a receiving pulse voltage defined as Vpulse_Rx=Vd−Vbias_Rx, and Vd refers to a transmission driving voltage.

### BRIEF DESCRIPTION OF THE DRAWINGS

The above and/or other aspects and advantages will become more apparent and more readily appreciated from the following detailed description of example embodiments, taken in conjunction with the accompanying drawings, in which:

FIG. 1 is a schematic view illustrating a structure of an ultrasonic diagnosis device according to some example embodiments;

FIG. 2 is a cross-sectional view illustrating an ultrasonic transducer according to some example embodiment;

FIG. 3 is a graph illustrating exemplary variations in displacement of a vibration membrane according to voltage applied to a capacitive micromachined ultrasonic transducer (cMUT);

FIG. 4A is a graph illustrating a driving signal according to some example embodiments;

FIGS. 4B and 4C are graphs illustrating exemplary first and second driving signals for forming the driving signal illustrated in FIG. 4A;

FIG. 5 is a graph illustrating results of an experiment in which the intensity of a transmission signal and the intensity of a receiving signal were measured according to a ratio of a direct current (DC) bias voltage and a pulse voltage;

FIG. 6 is a graph illustrating a driving signal for optimizing transmission sensitivity and receiving sensitivity, according to some example embodiments;

FIG. 7 is a graph illustrating exemplary first and second driving signals for forming the driving signal illustrated in FIG. 6;

FIG. 8 is a graph illustrating exemplary first and second driving signals for forming the driving signal illustrated in FIG. 6; and

FIG. 9 is a graph illustrating some example first and second driving signals for forming the driving signal illustrated in FIG. 6.

### DETAILED DESCRIPTION

Example embodiments will now be described more fully with reference to the accompanying drawings. Embodiments, however, may be embodied in many different forms and should not be construed as being limited to the embodiments set forth herein. Rather, these example embodiments are provided so that this disclosure will be thorough and complete, and will fully convey the scope to those skilled in the art. In the drawings, the thicknesses of layers and regions may be exaggerated for clarity.

It will be understood that when an element is referred to as being “on,” “connected to,” “electrically connected to,” or “coupled to” to another component, it may be directly on, connected to, electrically connected to, or coupled to the other component or intervening components may be present. In contrast, when a component is referred to as being “directly on,” “directly connected to,” “directly electrically connected to,” or “directly coupled to” another component, there are no intervening components present. As used herein, the term “and/or” includes any and all combinations of one or more of the associated listed items.

It will be understood that although the terms first, second, third, etc., may be used herein to describe various elements, components, regions, layers, and/or sections, these elements, components, regions, layers, and/or sections should not be limited by these terms. These terms are only used to distinguish one element, component, region, layer, and/or section from another element, component, region, layer, and/or section. For example, a first element, component, region, layer, and/or section could be termed a second element, component, region, layer, and/or section without departing from the teachings of example embodiments.

Spatially relative terms, such as “beneath,” “below,” “lower,” “above,” “upper,” and the like may be used herein for ease of description to describe the relationship of one component and/or feature to another component and/or feature, or other component(s) and/or feature(s), as illustrated in the drawings. It will be understood that the spatially relative terms are intended to encompass different orientations of the device in use or operation in addition to the orientation depicted in the figures.

The terminology used herein is for the purpose of describing particular example embodiments only and is not intended to be limiting of example embodiments. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which example embodiments belong. It will be further understood that terms, such as those defined in commonly used dictionaries, should be interpreted as having a meaning that is consistent with their meaning in the context of the relevant art and should not be interpreted in an idealized or overly formal sense unless expressly so defined herein.

Reference will now be made to example embodiments, which are illustrated in the accompanying drawings, wherein like reference numerals may refer to like components throughout.

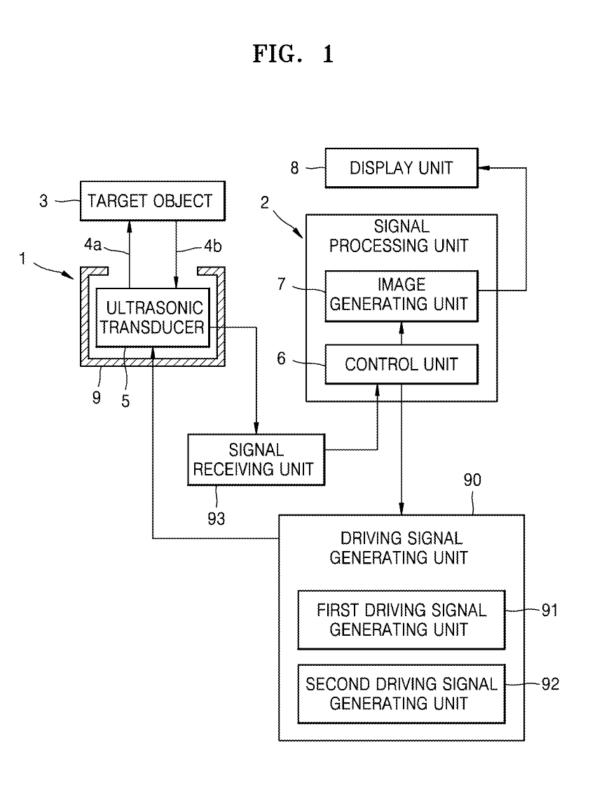

FIG. 1 is a schematic view illustrating the structure of an ultrasonic device according to some example embodiments. Referring to FIG. 1, the ultrasonic device includes an ultrasonic probe 1 and a signal processing unit 2. The ultrasonic probe 1 includes an ultrasonic transducer 5 for transmitting ultrasonic waves 4a to a target object (such as a human body) 3 and receiving ultrasonic waves 4b echoing from the target object 3. The ultrasonic transducer 5 is disposed in a housing 9.

The signal processing unit 2 controls the ultrasonic probe 1 and produces images of the target object 3 based on echo signals which are detected using the ultrasonic probe 1 and provide information about the target object 3. The signal processing unit 2 may include a control unit 6 and an image generating unit 7. The control unit 6 may control the ultrasonic transducer 5 so as to transmit and receive ultrasonic waves 4a and 4b. After the control unit 6 determines the position of the target object 3 to be irradiated with ultrasonic waves and the intensity of the ultrasonic waves, the control unit 6 may control the ultrasonic transducer 5. Those of ordinary skill in the related art will understand that the control unit 6 may additionally control general operations of the ultrasonic probe 1. For diagnosis, the ultrasonic transducer 5 may receive echo ultrasonic waves reflected from the target object 3 to generate an echo ultrasonic signal. The image generating unit 7 receives the echo ultrasonic signal and generates ultrasonic images of the target object 3 using the echo ultrasonic signal. General procedures for generating ultrasonic images using an echo ultrasonic signal will be apparent to those of ordinary skill in the related art, and thus descriptions thereof will not be provided. Ultrasonic images may be displayed on a display unit 8.

For example, the signal processing unit 2 may be configured by a processor including an array in which a plurality of logic gates are arranged, or by a combination of a general-purpose microprocessor and a memory storing a program executable on the microprocessor. Those of ordinary skill in the art to which example embodiments pertain will understand that the signal processing unit 2 may be configured by other appropriate hardware.

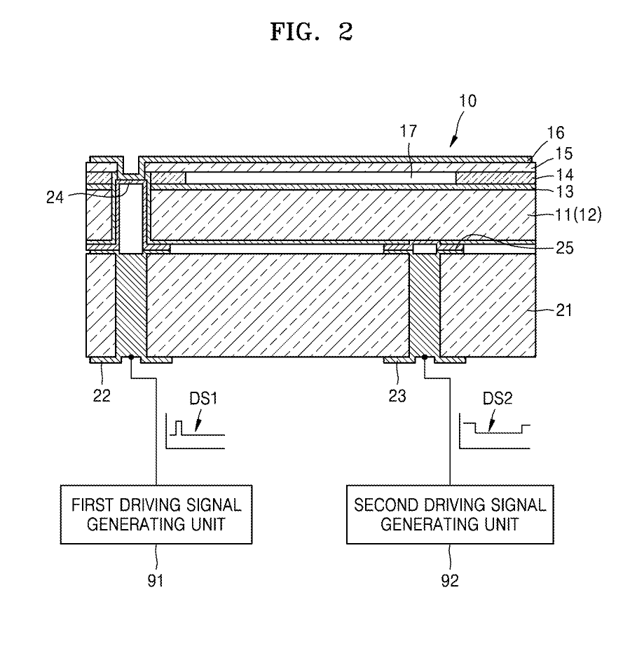

FIG. 2 is a cross-sectional view illustrating the ultrasonic transducer 5 according to some example embodiments. Referring to FIG. 2, the ultrasonic transducer 5 includes a plurality of ultrasonic cells 10. The ultrasonic cells 10 may be arranged in one-dimensional (1D) or two-dimensional (2D) form. Each of the ultrasonic cells 10 is an ultrasonic transducer and may be a piezoelectric micromachined ultrasonic transducer (pMUT), a capacitive micromachined ultrasonic transducer (cMUT), a magnetic micromachined ultrasonic transducer (mMUT), etc. In some example embodiments, the ultrasonic cells 10 are cMUTs. Since pMUTs use piezoelectric elements, it is limited to manufacture the pMUTs to have a small size. However, the size of cMUTs is several tens of microns (μm). Since it is possible to manufacture cMUTs through a series of semiconductor processes, a relatively large number of the ultrasonic cells 10 may be arranged in a given region when compared to the case of arranging pMUTs. Therefore, a high degree of diagnostic precision may be obtained, and high-resolution images may be obtained for diagnosis.

Referring to FIG. 2, a cMUT may be manufactured by forming a lower electrode 12, an insulation layer 13, a wall 14 on a substrate 11 to define a cavity 17, and disposing a vibration membrane 15, on which an upper electrode 16 is formed, on the wall 14. If the substrate 11 is a low resistive substrate, the substrate 11 may function as the lower electrode 12. Examples of the low-resistive substrate include silicon substrates, and the low-resistive substrate may be doped with a conductive material.

A capacitor is formed by the lower electrode 12, the vibration membrane 15 on which the upper electrode 16 is deposited, and the cavity 17 disposed therebetween. If a direct current (DC) bias voltage Vbias is applied between the pair of upper and lower electrodes 16 and 12, a displacement of the vibration membrane 15 is induced by an electrostatic force (Coulomb's force), and thus the vibration membrane 15 is slightly pulled toward the lower electrode 12. The vibration membrane 15 stops at a position where a reaction by internal stress is balanced with the electrostatic force. In this state, if a pulse voltage Vpulse (e.g., an alternating current (AC) voltage) is applied, the vibration membrane 15 starts to vibrate and generate ultrasonic waves. In a state where the vibration membrane 15 is moved by a displacement under the influence of a DC bias voltage Vbias, if an external ultrasonic pressure is applied to the vibration membrane 15, the displacement of the vibration membrane 15 is varied. This variation of the displacement changes electrostatic capacity. Thus, ultrasonic waves may be received by detecting a variation in electrostatic capacity. That is, if a cMUT is used, the transmission and receiving of ultrasonic waves are possible.

The ultrasonic transducer 5 may further include a driving substrate 21 disposed on a lower side of the substrate 11. A driving circuit (not shown), configured to drive the ultrasonic cells 10, and a receiving circuit (not shown), configured to receive echo ultrasonic waves from the ultrasonic cells 10, may be provided on the driving substrate. The driving substrate 21 includes a first electrode 22 electrically connected to the upper electrode 16, and a second electrode 23 electrically connected to the lower electrode 12. The first electrode 22 is electrically connected to the upper electrode 16 through a contact pad 24. The second electrode 23 is electrically connected to the lower electrode 12 through a contact pad 25. A first driving signal DS1 is applied to the upper electrode 16 through the first electrode 22, and a second driving signal DS2 is applied to the lower electrode 12 through the second electrode 23. The first and second driving signals DS1 and DS2 may be voltage signals.

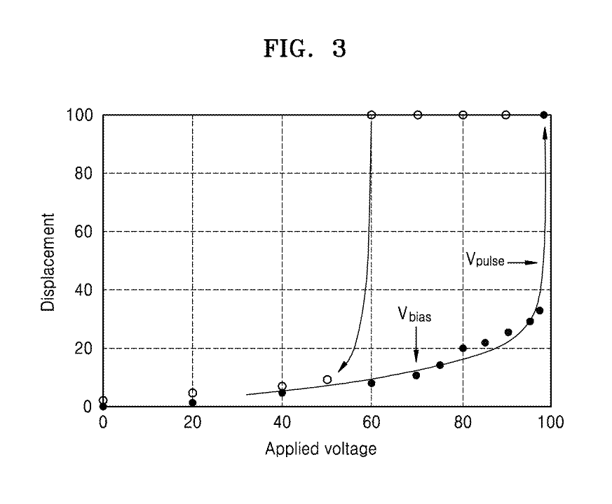

FIG. 3 is a graph illustrating exemplary variations in the displacement of the vibration membrane 15 according to voltages applied to a cMUT. Referring to FIG. 3, as it approaches a 100% displacement point, that is, a pull-in state, the displacement of the vibration membrane 15 is largely varied with respect to the variation in voltage, and thus a high driving efficiency may be obtained. Therefore, as described above, after a DC bias voltage Vbias is applied to one of the pair of upper and lower electrodes 16 and 12 (for example, the lower electrode 12) to shift an operation range to a high-efficiency range, a pulse voltage Vpulse is applied to the other of the pair of upper and lower electrodes 16 and 12 (for example, the upper electrode 16) to induce a dynamic motion.

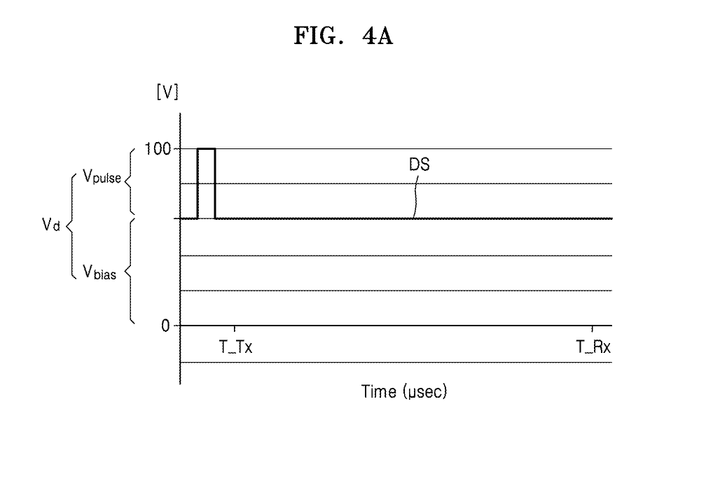

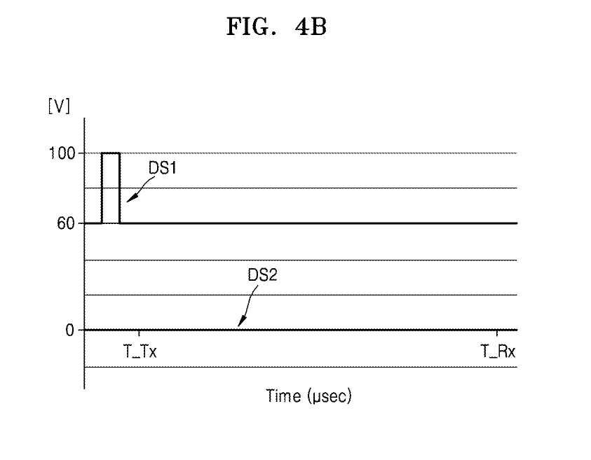

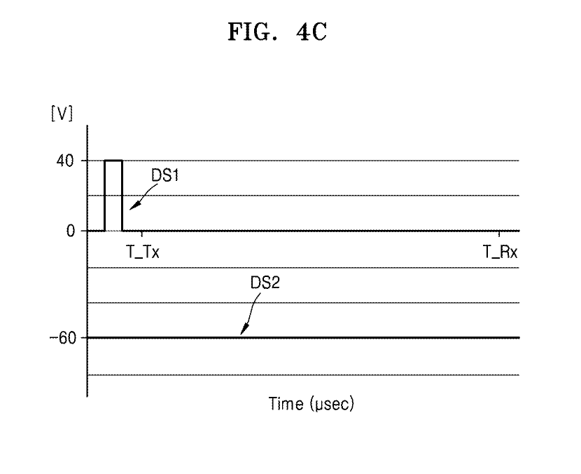

FIG. 4A is a graph illustrating a driving signal DS according to some example embodiments. FIGS. 4B and 4C are graphs illustrating exemplary first and second driving signals DS1 and DS2 for forming the driving signal DS illustrated in FIG. 4A. Referring to FIG. 4A, ultrasonic waves are generated and transmitted by applying a pulse voltage Vpulse (in volts (V)) for a relatively short period T_Tx (in microseconds (μsec)) while maintaining a DC bias voltage Vbias at a constant level, and a standby state is kept while maintaining the DC bias voltage Vbias (in V) for a relatively long period T_Rx (in μsec) so as to receive ultrasonic waves.

For example, the driving signal DS described above may be formed by a combination of the first driving signal DS1 applied to the upper electrode 16 and the second driving signal DS2 applied to the lower electrode 12 as shown in FIG. 4B. A driving voltage Vd refers to a potential difference between the upper electrode 16 and the lower electrode 12 in a transmission mode. Therefore, the driving voltage Vd of the driving signal DS shown in FIG. 4A may also be obtained by a combination of the first and second driving signals DS1 and DS2 shown in FIG. 4C. That is, a pulse voltage Vpulse resulting in a positive pulse is used as the first driving signal DS1 in FIG. 4B, and a pulse voltage Vpulse resulting in a negative pulse is used as the first driving signal DS1 in FIG. 4C.

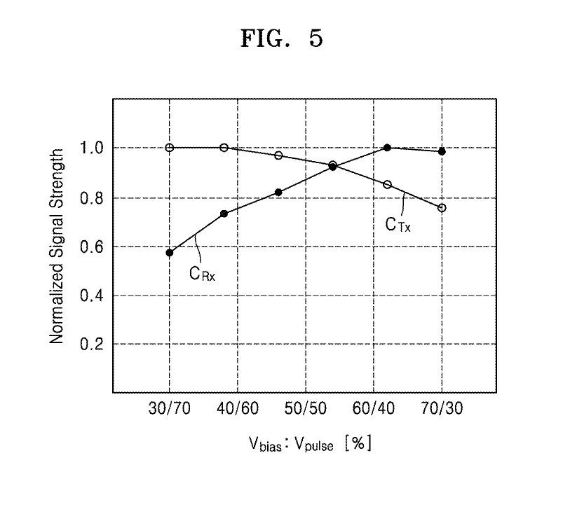

According to experimental results, transmission and receiving sensitivity depends on the ratio of a DC bias voltage Vbias and a pulse voltage Vpulse or the ratio of a DC bias voltage Vbias to a driving voltage Vd. FIG. 5 is a graph illustrating results of an experiment in which the intensity of a transmission signal and the intensity of a receiving signal were measured according to a ratio of a DC bias voltage Vbias and a pulse voltage Vpulse. In FIG. 5, C_{Tx} refers to the intensity of the transmission signal, and C_{Rx} refers to the intensity of the receiving signal. Hereinafter, Vpulse is defined by Vpulse=Vd−Vbias.

Referring to FIG. 5, the intensity of the transmission signal (transmission sensitivity) is high when Vbias:Vpulse=about 30:70 to about 40:60, and the intensity of the receiving signal (receiving sensitivity) is high when Vbias:Vpulse=about 60:40 to about 70:30. Since the ratio of Vbias:Vpulse is different between a point at which the transmission sensitivity is highest and a point at which the receiving sensitivity is highest, if the ultrasonic transducer 5 is operated under the condition in which one of the transmission sensitivity and the receiving sensitivity is highest, the other of the transmission sensitivity and the receiving sensitivity becomes low. That is, receiving efficiency is about 63% when the transmission sensitivity is highest at a point of Vbias:Vpulse=about 35:65, and transmission efficiency is about 80% when the receiving sensitivity is highest at a point of Vbias:Vpulse=about 65:35.

In some example embodiments, to address this situation and optimize both the transmission sensitivity and the receiving sensitivity, the ratio (%) of the DC bias voltage Vbias and the pulse voltage Vpulse is maintained as Vbias:Vpulse=about 30:70 to about 40:60 (a first ratio) in a transmission mode, and as Vbias:Vpulse=about 60:40 to about 70:30 (a second ratio) in a receiving mode. In other words, the ratio of the DC bias voltage Vbias to a driving voltage Vd is maintained to be about 30% to about 40% in the transmission mode and about 60% to 70% in the receiving mode, so as to optimize both the transmission sensitivity and the receiving sensitivity.

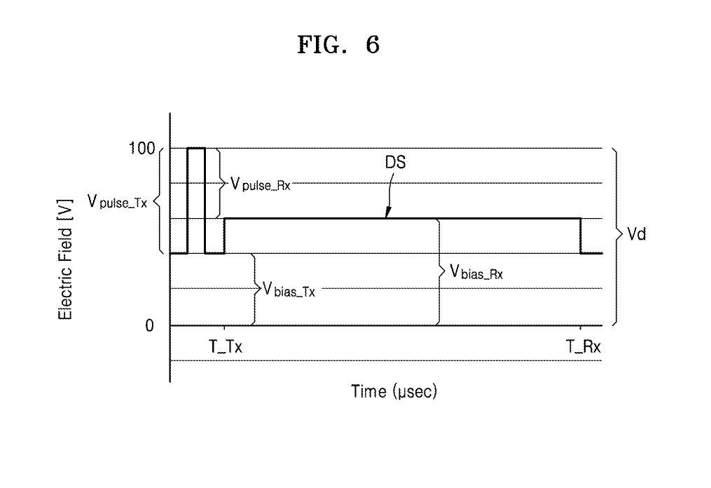

FIG. 6 is a graph illustrating a driving signal DS for optimizing transmission sensitivity and reception sensitivity, according to some example embodiments. In FIG. 6, the horizontal axis refers to time, and the vertical axis refers to potential. The potential shown in the vertical axis is not an absolute value, but a value relative to a driving voltage Vd of 100.

Referring to FIG. 6, a transmission bias voltage Vbias_Tx and a receiving bias voltage Vbias_Rx refer to a DC bias voltage in the transmission mode and a DC bias voltage in the receiving mode, respectively, and a transmission pulse voltage Vpulse_Tx and a receiving pulse voltage Vpulse_Rx refer to a pulse voltage in the transmission mode and a pulse voltage in the receiving mode, respectively. Practically, no pulse voltage is applied in the receiving mode. Therefore, the receiving pulse voltage Vpulse_Rx is defined as a value obtained by subtracting a DC bias voltage in the receiving mode, that is, the receiving bias voltage Vbias_Rx, from the driving voltage Vd.

According to the driving signal DS shown in FIG. 6, Vbias:Vpulse=Vbias_Tx:Vpulse_Tx=Vbias_Tx:(Vd−Vbias_Tx)=about 40:60 in the transmission mode, and Vbias:Vpulse=Vbias_Rx:Vpulse_Rx=Vbias_Rx:(Vd−Vbias_Rx)=about 60:40 in the receiving mode. In this manner, receiving sensitivity may be improved by about 20%.

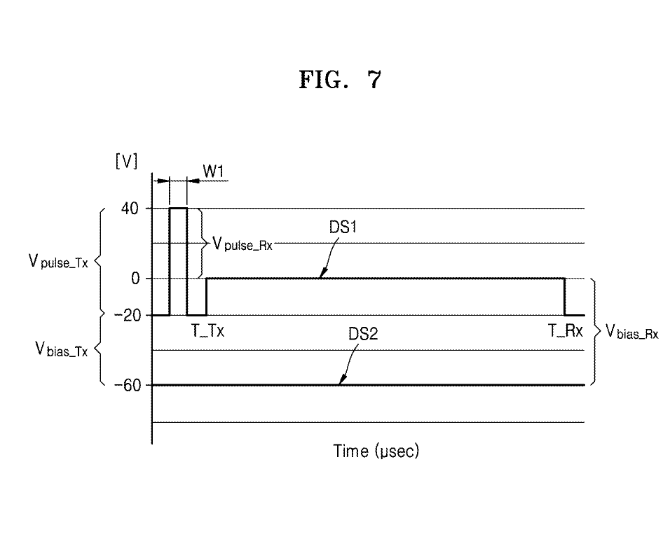

The driving signal DS shown in FIG. 6 may be formed by a combination of first and second driving signals DS1 and DS2 respectively applied to the upper electrode 16 and the lower electrode 12. FIG. 7 is a graph illustrating exemplary first and second driving signals DS1 and DS2 for forming the driving signal DS illustrated in FIG. 6. In FIG. 7, the horizontal axis refers to time, and the vertical axis refers to potential. The potential shown in the vertical axis is not an absolute value, but a relative value when a driving voltage Vd is put as 100.

Referring to FIG. 7, the second driving signal DS2 having a constant voltage is applied to the lower electrode 12 in the transmission mode and receiving mode, and the first driving signal DS1 modulated for forming Vpulse and Vbias is applied to the upper electrode 16. In this case, the driving signal DS shown in FIG. 6 may be formed for satisfying the following conditions: Vbias:Vpulse=Vbias_Tx:Vpulse_Tx=Vbias_Tx:(Vd−Vbias_Tx)=about 40:60 in the transmission mode, and Vbias:Vpulse=Vbias_Rx:Vpulse_Rx=Vbias_Rx:(Vd−Vbias_Rx)=about 60:40 in the receiving mode.

In the transmission mode, a transmission driving voltage Vpulse_Tx has a pulse width W1 within several microseconds to several tens of microseconds. The pulse width W1 is much smaller than a receiving mode time T_Rx and is also smaller than a transmission mode time T_Tx. Therefore, the first driving signal DS1 forming the transmission driving voltage Vpulse_Tx has a relatively high-frequency voltage. Since the first driving signal DS1 has a high-frequency driving voltage Vpulse_Tx sensitive to speed, it may be complex in terms of circuitry and costly to modify the first driving signal DS1 to form a transmission bias voltage Vbias_Tx and a receiving bias voltage Vbias_Rx.

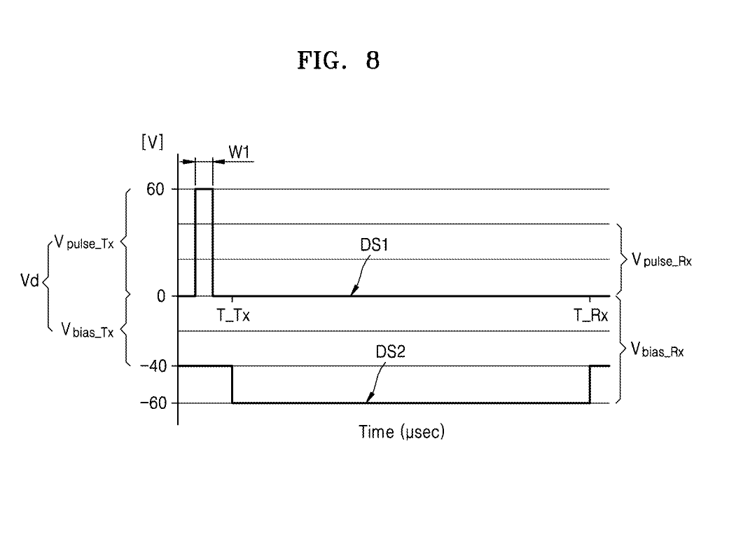

FIG. 8 is a graph illustrating exemplary first and second driving signals DS1 and DS2 for forming the driving signal DS illustrated in FIG. 6. Referring to FIG. 8, the first driving signal DS1 having a pulsed shape is applied to the upper electrode 16 to form a transmission pulse voltage (transmission driving voltage) Vpulse_Tx during a transmission period T_Tx in the transmission mode. The second driving signal DS2 is applied to the lower electrode 12 to form a transmission bias voltage Vbias_Tx during the transmission period T_Tx and a receiving bias voltage Vbias_Rx during a receiving period T_Rx. In this case, the driving signal DS shown in FIG. 6 may be formed for satisfying the following conditions: Vbias:Vpulse=Vbias_Tx:Vpulse_Tx=Vbias_Tx:(Vd−Vbias_Tx)=about 40:60 in the transmission mode, and Vbias:Vpulse=Vbias_Rx:Vpulse_Rx=Vbias_Rx:(Vd−Vbias_Rx)=about 60:40 in the receiving mode.

According to the first and second driving signals DS1 and DS2 shown in FIG. 8, the second driving signal DS2 which has a relatively low frequency and is thus less sensitive to speed is modulated to form the transmission bias voltage Vbias_Tx and the receiving bias voltage Vbias_Rx. Thus, the second driving signal DS2 may be generated using simple hardware with low costs. In addition, the first driving signal DS1 having the transmission driving voltage Vpulse_Tx which is a relatively high-frequency voltage sensitive to speed may be simplified. Therefore, according to the first and second driving signals DS1 and DS2 shown in FIG. 8, sensitivity may be improved both in the transmission mode and receiving mode, and a stable and inexpensive driving circuit may be formed.

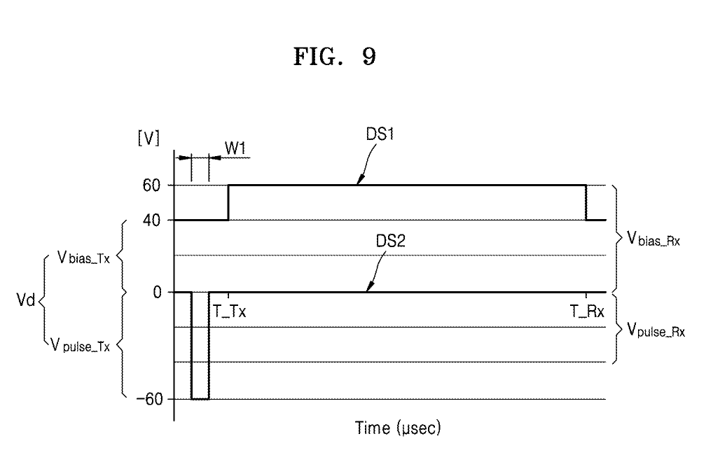

Since the driving voltage Vd of the driving signal DS means a potential difference between the upper electrode 16 and the lower electrode 12, the driving signal DS shown in FIG. 6 may be formed by first and second driving signals DS1 and DS2 shown in FIG. 9. That is, the first driving signal DS1 of FIG. 8 is formed by a positive pulse transmission driving voltage Vpulse_Tx, and the first driving signal DS1 of FIG. 9 is formed by a negative pulse transmission driving voltage Vpulse_Tx. In FIG. 9, Vpulse_Rx is defined as Vd−Vbias_Rx.

Referring to FIG. 1, the ultrasonic device includes a driving signal generating unit 90 to generate a driving signal DS. In the transmission mode, the driving signal generating unit 90 superposes a transmission bias voltage Vbias_Tx and a transmission pulse voltage Vpulse_Tx and applies the superposed voltages to the pair of lower and upper electrodes 12 and 16, and in the receiving mode, the driving signal generating unit 90 applies a receiving bias voltage Vbias_Rx that is different from the transmission bias voltage Vbias_Tx to one of the pair of lower and upper electrodes 12 and 16, for example, the lower electrode 12.

The driving signal generating unit 90 includes a first driving signal generating unit 91 to generate a first driving signal, and a second driving signal generating unit 92 to generate a second driving signal. The first driving signal generating unit 91 generates a first driving signal DS1 having a pulsed shape to form a transmission driving voltage Vpulse_Tx during a transmission period T_Tx in the transmission mode. The second driving signal generating unit 92 generates a second driving signal DS2 to form a transmission bias voltage Vbias_Tx during the transmission period T_Tx and a receiving bias voltage Vbias_Rx during a receiving period T_Rx. That is, the second driving signal generating unit 92 generates first and second driving signals DS1 and DS2 satisfying the following conditions: Vbias:Vpulse=Vbias_Tx:Vpulse_Tx=Vbias_Tx:(Vd−Vbias_Tx)=about 30:70 to about 40:60 in the transmission mode, and Vbias:Vpulse=Vbias_Rx:Vpulse_Rx=Vbias_Rx:(Vd−Vbias_Rx)=about 60:40 to about 70:30 in the receiving mode. A signal received in the receiving mode may be input to the control unit 6 through a signal receiving unit 93.

In this manner, the ultrasonic transducer 5 may maintain both the transmission efficiency and the receiving efficiency at high levels. Therefore, a high ultrasonic sound pressure may be generated in the transmission mode, and echo ultrasonic waves may be received at high sensitivity in the receiving mode. Therefore, the resolution of the ultrasonic device may be improved. In addition, since a DC bias voltage having a relatively low frequency is modulated to control the ratio of a pulse voltage and a bias voltage in the transmission mode and receiving mode, an electric driving circuit including the second driving signal generating unit 92 may have a simple structure and improved stability.

It should be understood that the example embodiments described herein should be considered in a descriptive sense only and not for purposes of limitation. Descriptions of features or aspects within each embodiment should typically be considered as available for other similar features or aspects in other embodiments.

While some example embodiments have been described with reference to the figures, it will be understood by those of ordinary skill in the art that various changes in form and details may be made therein without departing from the spirit and scope as defined by the following claims.

What is claimed is:

1. A method of operating a capacitive ultrasonic transducer including a pair of electrodes, the method comprising:
applying a first driving signal to one of the pair of electrodes to generate a transmission pulse voltage during a transmission period; and
applying a second driving signal to the other of the pair of electrodes to generate a transmission bias voltage during the transmission period and a receiving bias voltage that is different from the transmission bias voltage during a receiving period.

2. The method of claim 1, wherein the method satisfies the following conditions:
Vd=Vpulse_Tx+Vbias_Tx
Vbias_Tx:Vpulse_Tx=about 30:70 to about 40:60
where Vpulse_Tx refers to the transmission pulse voltage, Vbias_Tx refers to the transmission bias voltage, and Vd refers to a transmission driving voltage.

3. The method of claim 1, wherein the method satisfies the following conditions:
Vbias_Rx:Vpulse_Rx=about 60:40 to about 70:30
where Vbias_Rx refers to the receiving bias voltage, Vpulse_Rx refers to a receiving pulse voltage defined as Vpulse_Rx=Vd−Vbias_Rx, and Vd refers to a transmission driving voltage.

4. A method of operating an ultrasonic transducer including a pair of electrodes receiving a pulse voltage and a DC bias voltage, the method comprising:
modulating the DC bias voltage into a transmission bias voltage and superposing the transmission bias voltage and the pulse voltage so as to apply the superposed voltage to the pair of electrodes in a transmission mode; and
modulating the DC bias voltage into a receiving bias voltage that is different from the transmission bias voltage and applying the receiving bias voltage to one of the pair of electrodes in a receiving mode.

5. The method of claim 4, wherein if a potential difference between the pair of electrodes in the transmission mode is defined as a driving voltage, a ratio of the transmission bias voltage to the driving voltage is greater than or equal to about 30% and less than or equal to about 40%.

6. The method of claim 4, wherein if a potential difference between the pair of electrodes in the transmission mode is defined as a driving voltage, a ratio of the receiving bias voltage to the driving voltage is greater than or equal to about 60% and less than or equal to about 70%.

7. The method of claim 4, wherein the ultrasonic transducer is a capacitive micromachined ultrasonic transducer (cMUT).

8. An ultrasonic device, comprising:
an ultrasonic probe, comprising a pair of electrodes and a capacitive ultrasonic transducer, configured to transmit and receive ultrasonic waves;
a signal processing unit configured to generate information about an image of a target object from a received echo ultrasonic signal; and
a driving signal generating unit configured to apply a direct current (DC) bias voltage and a pulse voltage to the pair of electrodes;
wherein the driving signal generating unit is further configured to superpose a transmission bias voltage and a transmission pulse voltage and is configured to apply the superposed voltage to the pair of electrodes in a transmission mode, and
wherein the driving signal generating unit is further configured to apply a receiving bias voltage that is different from the transmission bias voltage to one of the pair of electrodes in a receiving mode.

9. The ultrasonic device of claim 8, wherein the driving signal generating unit comprises:
a first driving signal generating unit configured to generate the transmission pulse voltage; and
a second driving signal generating unit configured to generate the transmission bias voltage and the receiving bias voltage.

10. The ultrasonic device of claim 8, wherein the capacitive ultrasonic transducer satisfies the following conditions:
Vd=Vpulse_Tx+Vbias_Tx
Vbias_Tx:Vpulse_Tx=about 30:70 to about 40:60
where Vpulse_Tx refers to the transmission pulse voltage, Vbias_Tx refers to the transmission bias voltage, and Vd refers to a transmission driving voltage.

11. The ultrasonic device of claim 8, wherein the capacitive ultrasonic transducer satisfies the following conditions:
Vbias_Rx:Vpulse_Rx=about 60:40 to about 70:30
where Vbias_Rx refers to the receiving bias voltage, Vpulse_Rx refers to a receiving pulse voltage defined as Vpulse_Rx=Vd−Vbias_Rx, and Vd refers to a transmission driving voltage.
